(19) United States
(12) Patent Application Publication
(10) Pub. No.: US 2021/0379802 A1
(43) Pub. Date: Dec. 9, 2021

(54) INJECTION MOLD SYSTEM AND METHOD FOR INJECTION MOLDING

(71) Applicant: STRUCTUR3D PRINTING INCORPORATED, Kitchener (CA)

(72) Inventors: Charles MIRE, Waterloo (CA); Andrew FINKLE, Kitchener (CA); Trevor SMALE, Etobicoke (CA)

(21) Appl. No.: 17/280,689

(22) PCT Filed: Oct. 9, 2019
(86) PCT No.: PCT/CA2019/051440

§ 371 Date: Mar. 26, 2021

Related U.S. Application Data
(60) Provisional application No. 62/743,754, filed on Oct. 10, 2018.

(51) Int. Cl. B29C 45/13; B29C 45/77; B29C 45/34; B29C 45/00

(52) U.S. Cl. CPC B29C 45/13; B29C 45/77; B29C 45/34; B29C 45/0055; B29K 2063/00; B29C 2945/762; B29C 2945/76545; B29C 2945/76678; B29C 2945/76006

(57) ABSTRACT

There is provided an injection mold system and a method for injection molding to produce a three-dimensional object. The system including: one or more extruders each adapted to receive one or more cartridges, the one or more cartridges containing extrudable material; an injection nozzle dimensioned to be positioned into an injection inlet of a mold; tubing each connecting one of the cartridges to the injection nozzle; and one or more controllers configured to control flow of the extrudable material from the one or more extruders to the injection nozzle to fill at least a portion of the interior chamber with the extrudable material to produce the three-dimensional object.

### TECHNICAL FIELD

The present invention relates generally to the field of producing three-dimensional (3D) objects, and more particularly to an injection mold system and method for injection molding.

### BACKGROUND

In recent years, 3D printing has seen rapid growth as new processes are developed for additive manufacturing of 3D objects, whereby a 3D object of virtually any shape can be formed by adding successive layers of materials. This has allowed the development of new manufacturing processes such as rapid prototyping, and manufacturing of custom parts or replacement parts.

Common forms of additive processes include extrusion deposition, granular materials binding, lamination, and photopolymerization. With extrusion deposition, small beads of material are extruded from a nozzle to be fused to material that has already been laid down. Common types of materials used in extrusion deposition include thermoplastics and metals, typically supplied as filaments or wire that is unreeled and melted just prior to extrusion through a nozzle head. By extruding successive layers of beads of material through a nozzle under the control of one or more controller driven motors, it is possible to form articles with highly complex shapes that have heretofore not been possible, or prohibitively expensive to manufacture. However, additive processes that use rubber materials, foam, or epoxies, in small batches or limited quantities, are generally expensive and inefficient.

### SUMMARY

In an aspect, there is provided an injection mold system for producing a three-dimensional object using a mold, a portion of the mold defining an interior chamber and defining an injection inlet from the interior chamber to the exterior of the mold, the system comprising: one or more extruders each adapted to receive one or more cartridges, the one or more cartridges containing extrudable material; an injection nozzle dimensioned to be positioned into the injection inlet; tubing each connecting one of the cartridges to the injection nozzle; and one or more controllers configured to control flow of the extrudable material from the one or more extruders to the injection nozzle to pressure fill at least a portion of the interior chamber with the extrudable material to produce the three-dimensional object.

In a particular case of the system, the extrudable material comprises one of rubber, foam, and epoxy.

In another case of the system, the system further comprising one or more pressure sensors positioned in association with the one or more cartridges to detect back pressure applied by the extrudable material against the one or more cartridges.

In yet another case of the system, the controller directs the one or more extruders to cease flow of the extrudable material when the sensed pressure is above a predetermined threshold.

In yet another case of the system, a previously molded object is located inside the interior chamber, and wherein flow of the extrudable material into the interior chamber produces the three-dimensional object as an overmolded object.

In yet another case of the system, the controller directs the one or more extruders to cease flow of the extrudable material when a predetermined volume of extrudable material has been injected into the interior chamber.

In yet another case of the system, one or more of the cartridges contains a gas that when directed into the interior chamber creates a void for blow molding.

In yet another case of the system, an insert is located inside the interior chamber, and wherein flow of the extrudable material into the interior chamber produces the three-dimensional object with the insert as part of the three-dimensional object.

In yet another case of the system, the insert is comprised of dissolvable material.

In yet another case of the system, the mold further comprises a pocket located between the interior chamber and the injection nozzle for receiving excess extrudable material.

In yet another case of the system, the controller controls extrusion speed at two or more of the extruders to inject extrudable material from each extruder at a predetermined mixing ratio.

In yet another case of the system, the mold comprises one or more vents between the interior chamber and the exterior of the mold to permit air to escape during flow of the extrudable material into the interior chamber.

In another aspect, there is provided a method for injection molding to produce a three-dimensional object using a mold, a portion of the mold defining an interior chamber and defining an injection inlet from the interior chamber to the exterior of the mold, the method comprising: receiving one or more cartridges, the one or more cartridges containing extrudable material; passing the extrudable material from each of the one or more cartridges to an injection nozzle positioned into the injection inlet; and pressure filling at least a portion of the interior chamber with the extrudable material to produce the three-dimensional object.

In a particular case of the method, the extrudable material comprises one of rubber, foam, and epoxy.

In another case of the method, the method further comprising detecting back pressure applied by the extrudable material against the one or more cartridges and ceasing flow of the extrudable material when the sensed pressure is above a predetermined threshold.

In yet another case of the method, the method further comprising positioning a previously molded object inside the interior chamber, and wherein filling at least a portion of the interior chamber with the extrudable material produces the three-dimensional object as an overmolded object.

In yet another case of the method, the method further comprising ceasing flow of the extrudable material when a predetermined volume of extrudable material has been injected into the interior chamber.

In yet another case of the method, one or more of the cartridges contains a gas, the method further comprising passing the gas into the interior chamber to create a void for blow molding.

In yet another case of the method, the method further comprising positioning an insert inside the interior chamber, and wherein filling at least a portion of the interior chamber with the extrudable material produces the three-dimensional object with the insert as part of the three-dimensional object.

In yet another case of the method, the method further comprising controlling extrusion of extrudable material from two or more cartridges at a predetermined mixing ratio.

These and other embodiments are contemplated and described herein. It will be appreciated that the foregoing summary sets out representative aspects of various embodiments to assist skilled readers in understanding the following detailed description.

### DESCRIPTION OF THE DRAWINGS

A greater understanding of the embodiments will be had with reference to the Figures, in which:

FIG. 1 shows a conceptual diagram of an injection mold system, in accordance with an embodiment;

FIG. 2 illustrates a diagrammatic front view of an example implementation of the system of FIG. 1;

FIG. 3 illustrates another example implementation of the system of FIG. 1;

FIG. 4 illustrates an example of an extruder without the housing, in accordance with the system of FIG. 1;

FIG. 5 illustrates another example of an extruder without the housing, in accordance with the system of FIG. 1;

FIG. 6 illustrates yet another example of an extruder without the housing, in accordance with the system of FIG. 1;

FIG. 7 illustrates yet another example of an extruder without the housing, in accordance with the system of FIG. 1;

FIG. 8 illustrates yet another example implementation of the system of FIG. 1;

FIG. 9 shows a flow chart of a method for injection molding, in accordance with an embodiment; and

FIG. 10 illustrates another example implementation of the system of FIG. 1

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

It will be appreciated that for simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

It will be appreciated that various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender. Further definitions for terms may be set out herein; these may apply to prior and subsequent instances of those terms, as will be understood from a reading of the present description.

It will be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The present disclosure relates to an injection mold system and method for injection molding.

Rapid or custom fabrication of products by additive processes, according to previous approaches, using rubber materials, foam, or epoxies, as one-offs, in small batches, or in limited quantities, is generally expensive and inefficient. Some approaches, like high pressure injection molding, are used only at large scales (for example, at the factory scale) where economies are optimized for high volume output.

For large scale factory systems, extrudable materials are generally either liquid at room temperature, or generally made liquid by melting with applied heat. Materials that are liquid at room temperature may be drawn by vacuum from storage drums. Materials that must be melted may originate in pellet form and be fed into the injection mold machine by way of a hopper mechanism. The liquid material is generally injected into the mold in rapid succession.

Approaches for small batch injection mold systems generally process hot-melt materials, such as plastic, and are not well-suited for rubber materials, foam, or epoxies. In some cases, small batch injection mold systems are simply inefficient and expensive scaled-down versions of large factory scale systems. In addition, such injection molding machines generally require full purging cycles when switching from one material to another; commonly known as “retooling.” This operation can result in larger volumes of waste material, and effectively shuts down the injection mold system down during this operation.

Other approaches may use plastic 3D printed molds for casting rubber materials. However, this approach involves pouring the liquid rubber into the mold from the top; i.e., a method known as “casting.” Air bubbles can commonly be trapped within the mold. Additionally, this approach is generally limited to only materials that can be poured. Additionally, this approach is typically done by hand, and does not allow for pressure to push the material thoroughly into the mold, nor does it allow for scalability due to the lack of automation.

Other approaches, such as direct 3D printing of rubber or rubber-like materials, generally require very customized material formulations. Often, these materials contain photopolymers for curing by ultra-violet light; and the use of an ultra-violet light source adds additional safety requirements, along with a post-processing wash cycle to clean any uncured material from the print.

Advantageously, embodiments of the present disclosure provide an approach for material dispensing into injection molds at a small batch scale (also referred to as a “custom scale”, “limited quantities scale,” or “desktop scale”). The present embodiments can generally be used in a non-factory environment (for example, a lab or office). Advantageously, by using a mold as a physical support of viscous liquid injectable material, complex geometries are possible to produce. In some cases, having the molds being 3D printed can provide rapid iteration and customization economics. In some cases, as described herein, using dissolvable filament to 3D print a mold can enable end-products that would be generally extremely difficult to achieve using other injection molding approaches. In some cases, complex geometries are possible because of the ability to use dissolvable material in the mold. Release from the mold by minimal force (the mold being dissolved away) means that delicate and fragile parts can be produced at small-batch scales that are generally not possible otherwise.

Embodiments of the present disclosure provide a small-batch injection mold system. In some cases, the molds can be previously produced; for example, after 3D printing. Advantageously, the deposition materials can be fully contained within cartridges and, thus, there is reduced waste of material and less time lost to “retooling.”

Embodiments of the present disclosure can use extrudable material pre-packaged into cartridges (or empty cartridges that are filled by an end-user). In some cases, the material can be injected if it is liquid at room temperature, or melted by a heat source located proximate the cartridge prior to being injected into the mold. Advantageously, embodiments of the present disclosure have a material cartridge feed approach that do not require the mechanics of the injection system to directly contact the materials. Advantageously, this eliminates any requirement for the system to be purged when switching between materials. The lack of direct mechanical contact with the materials also improves the injection into the mold because it allows for rapid switching between different materials with nearly zero down time.

Embodiments of the present disclosure can provide controlled injection pressure that eliminates the issues presented by casting, such as air bubbles or incomplete filling of the mold. Other approaches can rely on gravity to fill a mold. If the geometry of the mold is sufficiently complex, small air pockets may become trapped by the flow of the material into the mold, producing a defective product. In the present embodiments, by pressure injecting the molds from the bottom area of the mold, air is allowed to escape; for example, through small, intentionally designed vents near the top of the mold, ensuring the mold is completely filled. Being able to sense and control the pressure ensures that the system can completely fill the volume of the mold. In some cases, if a pressure increase is detected before the full volume has been completely injected, the system can react and increase the flow rate and pre-defined pressure to ensure complete filling of the mold.

Embodiments of the present disclosure also allow for overmolding, which can be made to encapsulate other solid parts, or electronics and sensors. As with solid molded parts, trapped air bubbles are not desirable, so pressure injection (for example, with intentionally designed vents allow air to escape) ensures complete filling of the mold and encapsulation of the object within the overmold. Overmolding can be used for various applications; for example, for combining different small pieces made from different materials into a single part or product by injecting a bulk material to envelope the small pieces. Another application for overmolding can be for embedding sensors or electronics into a part or product.

Advantageously, embodiments of the present disclosure can use many different types of factory-grade materials (in some cases, thousands of types), without the need to add photopolymers or develop new, smaller material subsets to fit within narrow process constraints. Embodiments of the present disclosure allow for material selection that is much broader than with other approaches, because optimization tolerances for operation are not as strict, and the system can be designed to handle the given parameters for thousands of materials. The optimization tolerances for the present embodiments are not as strict because the system can work with materials that generally cannot be poured into a mold using a casting approach (i.e., where the material viscosity is too high). While some large-scale factory systems can handle high viscosity materials, the present embodiments provide such capability to the desktop scale. In this way, the present embodiments allow the use of both low and high viscosity materials and thus expands the material selection available at the desktop scale.

In some cases, sensors associated with embodiments of the system can provide a feedback loop for injection pressure; such that a consistent pressure can be maintained throughout the injection of the material. In some cases, a volume of material that is injected can be precisely programmed to allow for process repeatability.

In some cases, embodiments of the system can determine an amount of “over-injection” such that any air in a mold is completely purged and the molding space is properly filled with the injected material. In some cases, the user can input a volume of the mold and a number of vents designed into the mold; where more complex molds may have more vents. The system can then add an additional percentage of the total volume entered by the user for each vent, resulting in over-injection of a larger total volume to be injected.

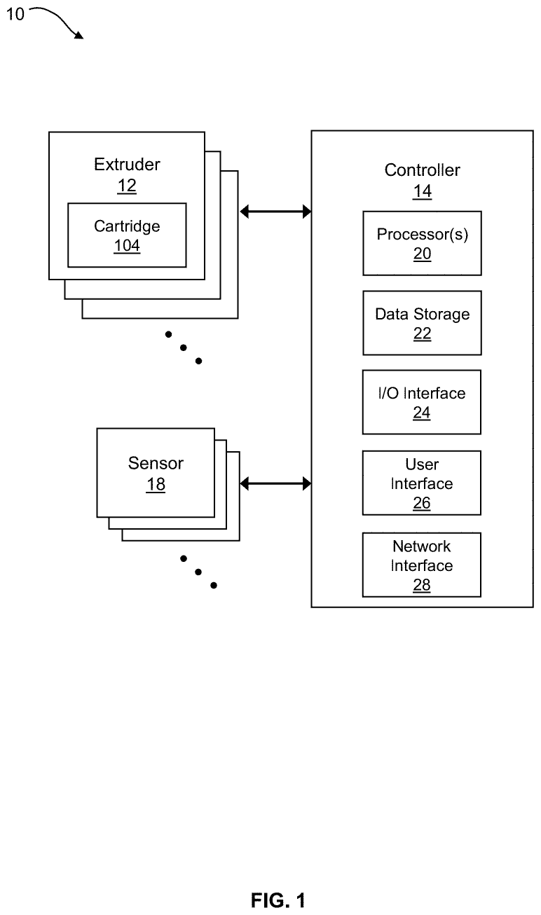

Turning to FIG. 1, a conceptual diagram of an injection mold system 10, according to an embodiment, is shown. In some cases, the controller 14 can be a computing device. In some cases, the controller 14 can be a hard-coded or dedicated piece of hardware. In further cases, the functions of the controller 14 can be located on another computing device, for example a desktop, laptop, smartphone, server, distributed computer, or the like. The system 10 includes one or many material extruders 12 controlled by a controller 14. The controller 14 can communicate with the extruders 12 and sensors 18 via an I/O interface 24. The controller 14 includes one or more processors 20 in communication with a data storage 22; for example, a RAM, a cache, a hard-drive, a remote database, or the like. The data storage 22 including instructions that when executed by the one or more processors 20 execute the functions of the controller 14. A user may interact with the controller 14 using an input device connected to a user interface 26. The input device can include, for example, a mouse, keyboard, touchscreen, microphone, or the like. The controller 14 may interact with the user using an output device connected to the user interface 26. The output device may include, for example, a display, a touchscreen, speakers, LEDs, or the like. The controller 14 may form part of a network via a network interface 28, allowing the computer device 600 to communicate with other computing devices or circuits. FIG. 11 illustrates an example embodiment of a housing 1100 for housing of the controller 14.

Each of the material extruders 12 is controlled by the controller 14. Each of the material extruders 12 includes one or more cartridges 104. In some cases, the cartridges 104 can be disposable or refillable. The controller 14 can control the material extruders 12 and intelligently respond to material injection dynamics. The response can be fully automated or based on added guidance of user input for specified parameters.

In some cases, a material can be given a predetermined value for the pressure it requires to inject it into the mold. The user can input this predetermined value, for example, prior to initiating injection molding. As described herein, pressure sensors 18 can be used to provide pressure feedback data to the controller 14 as the material is being injected. In some cases, once the predetermined pressure value is reached, the controller 14 directs maintaining this pressure until a predetermined volume of the mold has been filled. If the pressure sensors 18 detect an increase in pressure before the predetermined volume of the mold has been completely injected, the controller 14 can respond by increasing the pressure further than the predetermined pressure value to ensure complete injection of the mold.

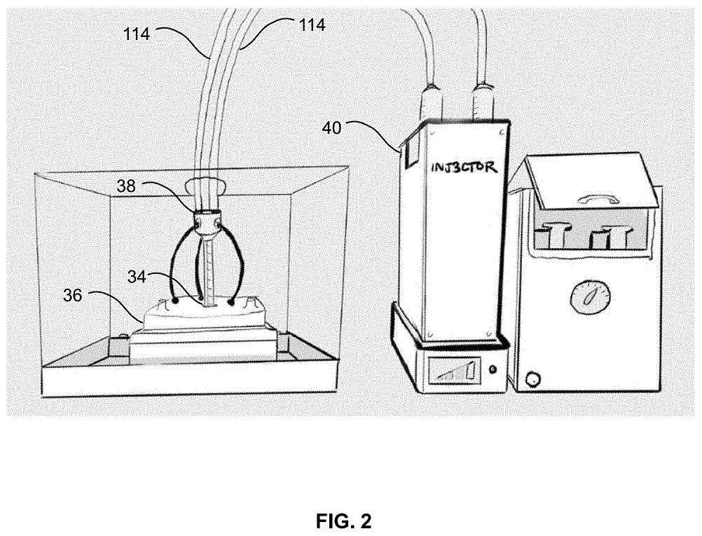

FIG. 2 illustrates a diagrammatic front view of an example implementation of the system 10. The one or more cartridges, in this example two cartridges, are connected by way of tubing 114 (in some cases, disposable tubing) to an inlet 34 defined by a mold 36. The material is forced from the cartridges 104, through the tubing 114, into the inlet 34 where it is injected into the mold 36. In some cases, an injection nozzle 38, connected to the end of each tubing 114, can be connected by, for example, a luer lock mechanism or by inserting a disposable nozzle connected to the tubing. In this example, the extruders 12 with the cartridges 104 are located with a housing 40.

The cartridges 104 may be filled with materials by the user, or may be filled in advance by a supplier. In some cases, the pre-filled cartridges 104 can have an identification (ID) mechanism, such as an embedded ID chip, that can be read by the system 150, such as via a sensor. In some cases, material profile data can be contained in the embedded ID chip, and this profile data can be automatically loaded into the controller 14. Material profile data generated by user input or the embedded ID chip may also be retrieved from an external system or database, for example, over the Internet. In this manner, the external database can up-to-date material profile information that can be used to override the embedded ID chip data or user-defined data. Further, the external database containing material profiles can enable enterprise distribution of private material profiles within the enterprise or externally. In some cases, usage data can be collected for either cartridges filled by the user or pre-filled cartridges, and further data can be collected by the system 10.

The mold 36 can be produced using any suitable approach; for example, three-dimensional (3D) printing, manual techniques (e.g., carving), computer numerical control (CNC) milling, casting, formed by nature (e.g., the tunnels of an ant colony, the shell of a nut, or the cavity in a section of bamboo), or the like. In some cases, the mold 36 may include different cores or inserts to allow for the creation of more complex geometries and sharper edges. In some cases, these cores or inserts may be solid objects intended for physical removal from the injected material once the injected material is cured. In some cases, these cores or inserts may be composed of dissolvable material to make removal easier. In other cases, these cores or inserts may be objects intended to be permanently retained within the injected material (for example, where the injected material is “overmolded”). Permanently retained objects can include, for example, electronic components, handles, skeleton structures for mechanical support, and the like. In some cases, overmolding may be performed in a stepwise sequence, where small parts are injection molded first, then these small parts are inserted into a larger mold for overmolding. By way of example, rubbers sections of different hardnesses can be injection molded, then inserted into a larger mold for a shoe insole, into which a bulk softer material is injected in order to combine all the separate parts into a final unit. In some cases, the mold can be composed of two different materials, such that one material may be removed (by dissolving, burning, melting, or other removal method) so as to leave behind a cavity. Another material can then be injected into the cavity created by the removal process to create a multi-material or multi-property final unit.

In some cases, the mold 36 can include a pocket or reservoir in fluid communication with the main mold interior chamber, with a path allowing material to drain back into the main chamber. The controller 14 can add an extra volume of material, in addition to the main chamber volume, to inject into the mold such that the designed pocket will receive the excess material. Should the mold leak, the excess material in the designed pocket will drain back into the main chamber to replace the leaked material and minimize the possibility of air pocket defects in the main chamber.

In an embodiment, the one or more extruders 12 can dispense a single component material that does not require mixing. In an embodiment, the one or more extruders 12 can dispense materials from two or more cartridges 104 that are combined or reacted in a mixing element prior to being injected into the mold 36. The controller 14 can govern the one or more extruders 12 such that the material dispensing occurs at different ratios or speeds; for example, to affect a mixing of each extruded material in specific ratios (for example, as specified by material formulations).

In cases where the two cartridges 104 contain material to be mixed upon injection, the controller 14 can automatically determine different volumes to dispense from the two different cartridges based on predetermined mixing ratios. In an example, the user can input that a mixing ratio is 2:3. In this example, a total volume can be 100 mL, and each cartridge can have a volume of 60 mL. Thus, the controller 14 extrudes material from the first cartridge 10 at a 3 to 2 volumetric translation with the second cartridge. In this way, the controller 14 directs that the full 60 mL of the first cartridge is extruded while only 40 mL of the second cartridge is extruded. Thus, the dispensing rate of the 40 mL volume will be slower so as to inject the full 40 mL into the mold in the same time as the other cartridge extrudes the full 60 mL. In some cases, in order to achieve such mixing ratios, the controller 14 can add an amount of extra volume to dispense during the priming process before the tubing 114 is connected to the injection nozzle 38, for the purpose of clearing any non-optimal initial mixing ratios as the system reaches equilibrium. In some cases, the controller 14 can indicate, via a user interface, that such initial volume dispensing is complete so the user can know when to connect the tubing to the injection mold. In some cases, the controller 14 can add an amount of extra volume to dispense at the end of the injection process to ensure complete injection of the mold.

After the mold has been filled with the extrudable material, in some cases, it may be left for a specified curing duration for the material. In some cases, applying external heat to the mold may accelerate the curing time. In some cases, a heating or cooling device, controlled by the controller 14, may be used to affect the material conditions at the one or more extruders 12 and/or at the mold 36. In some cases, the heating or cooling device can be a sleeve that fits over the cartridges 104 and tubing 114. In some cases, the heating and cooling device can be a thermally conductive plate under the mold 36 to speed up curing time. In some cases, the heating or cooling device can be a closed chamber into which the mold 36 is placed to maintain a uniform temperature within the mold 36 and/or heat it up to speed up curing time.

In some cases, various sensors 18, in communication with the controller 14, can be used to measure pressure. The controller 14 can use these sensor readings to dynamically respond to the pressure feedback. This pressure feedback can be used to signal when the injection mold is sufficiently (or completely) filled, and thus, the controller 14 can automatically cease injecting the material. In an example, each pressure sensor 18 (e.g. potentiometer) can be located in a respective cartridge 104 to detect back pressure applied by the material against the cartridge 104. The pressure sensors 18 can also be used to control injection in real-time, to avoid undue pressure which may cause damage.

In some cases, the controller 14 can record data for each injection molding, and where the sensors 18 detect an increase in pressure (i.e., flow resistance before a predetermined volume of material has been completely injected into the mold), the controller 14 can respond by directing further increases in flow rate and/or pressure. In some cases, the controller 14 can store the final pressure value once the predetermined volume of material has been injected. Subsequent injection molding operations can then be monitored for completion using both the stored final pressure value and the predetermined volume of material.

In some cases, a user can provide inputs to the injection molding; for example, dispensing speed and total volume to dispense into the mold. In some cases, the sensors 18 can detect a sudden pressure drop, which could indicate that the mold has failed in some manner, and this detection can be fed back to the controller 14, which can then cease injection.

In some cases, a scale can be located below the mold to determine the weight of the material injected into the mold. The controller 14 can use these weight readings to determine when the injection mold is sufficiently (or completely) filled, for example when a predetermined weight threshold has been passed; and thus, the controller 14 knows when to automatically cease injecting the material.

In some cases, the controller 14 can take into account the viscosity of the material for injection molding. In some cases, the user can input the viscosity of the material being dispensed. The controller 14 can use the viscosity to automatically select the appropriate injection speed to use. In some cases, the controller 14 can auto-select injection parameter settings based on the viscosity value inputted by a user and/or by using a library of parameter settings for same or similar materials. For example, if a user wishes to inject a custom silicone rubber material with a given viscosity value, the controller 14 can automatically load additional injection parameter settings, such as injection speed, for a known silicone of the same (or similar) viscosity value from the library.

In some cases, the controller 14 can take into account the expansion or contraction (or any chemically or thermally governed volume change) coefficient of a foaming or other reactive material. In some cases, this coefficient can be inputted by the user. The controller 14 can factor the total volume required for the mold 36 against this expansion or contraction coefficient so the correct amount of material per volume is injected. In some cases, the controller 14 can auto-select injection parameter settings based on expansion or contraction values inputted by the user and/or by using parameter settings for same or similar materials in a library. For example, if a user wishes to inject a custom foam material with a given expansion value, the controller 14 can automatically load additional injection parameter settings, such as injection speed, for a known foam of the same (or similar) expansion value from the library.

In some cases, multiple user inputs can be combined into a specific material profile. In some cases, an injection mold profile can be inputted in which a material profile is selected, and the total mold volume is stored. The specific material profile and/or the injection mold profile can be saved into storage on the local data storage 22, stored on removable media (e.g., SD card or USB drive), or stored on a remote database, to allow for quick set up of repeat injection mold operations.

In some cases, an extruder 12 with an empty cartridge 104 can be connected by tubing 114 to the top section of a mold 36, and the extruder 12 can be directed by the controller 14 to move in reverse. In these cases, a vacuum is created to pull the injected material further into the mold or remove air from the mold. In some cases, one or more of the cartridges 104 can contain air or a specific gas to be injected into the mold 36 to aid with the material reactions or to create a void for blow molding. In an example, using an extruder 12 to inject air, or other gas, enables the system 10 to be used as a desktop blow mold system. By way of example, use of the desktop injection system as a desktop blow mold system can enable a secondary material of different composition to be injected into the cavity inside the first material deposited by the blow mold.

In an example, a coaxial injection nozzle arrangement can be used to enable the system 10 to function as a blow mold system. The internal outlet of the coaxial nozzle could connect to an air source or cartridge (such as a CO₂ cartridge), while the outer outlet of the coaxial nozzle could inject the primary injection material. The effect of using the coaxial nozzle would be to create an air bubble inside the material than can be inflated so that the outer wall of the bubble rests and cures at the edges of the mold. The ratio of air and material can be customized based on the material parameters and mold geometries.

In some cases, the system 100 can also include a gantry mechanism, controlled by the controller 14, to automatically position the injection nozzle to the injection inlet on the mold. In some cases, a heating element can be located underneath, or otherwise in proximity to, the mold to provide heat to assist with curing the injected material in the mold. In some cases, the mold can be enclosed in a controlled environmental housing to precisely maintain humidity and temperature.

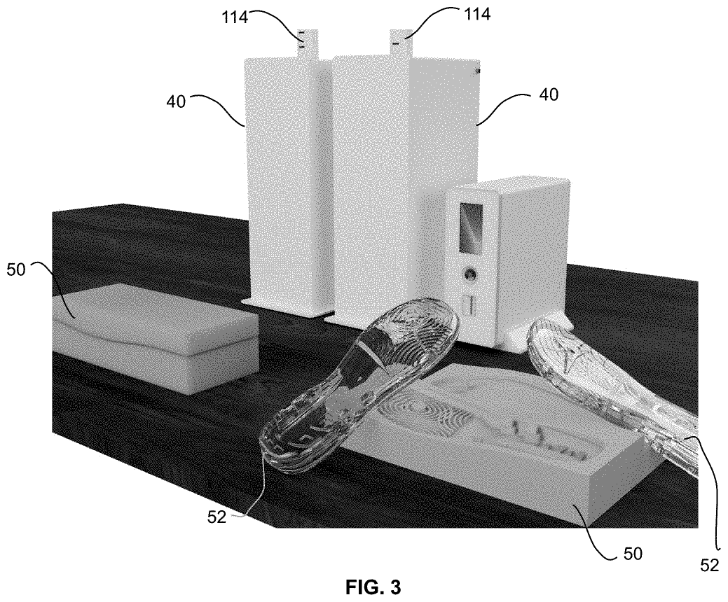

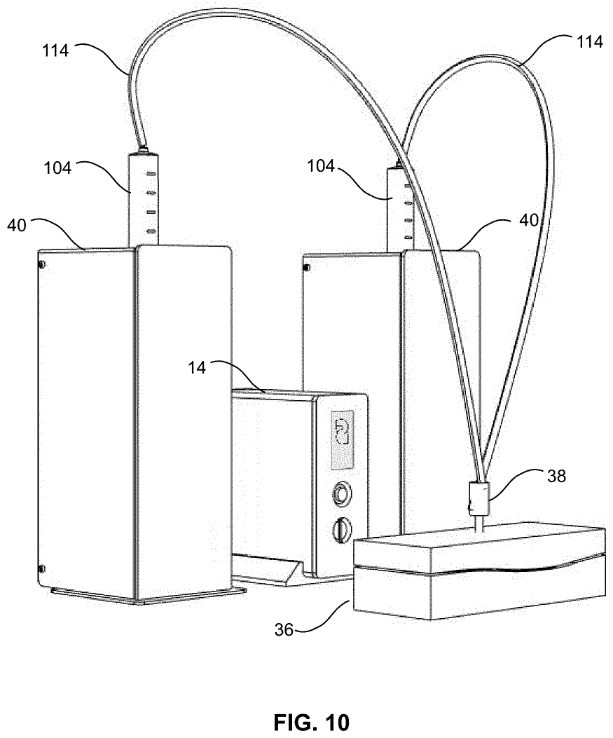

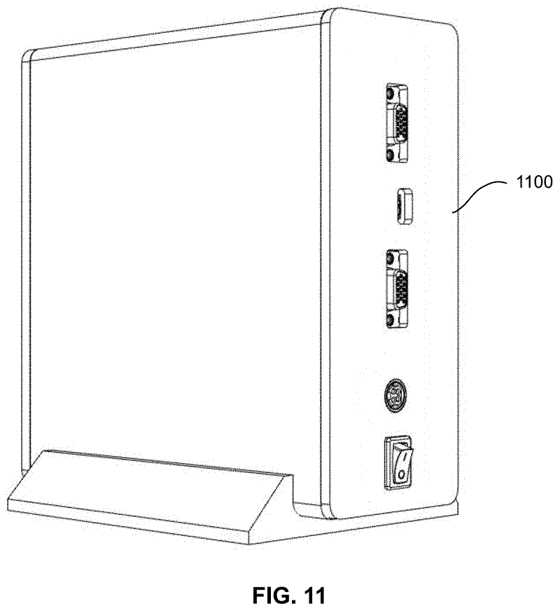

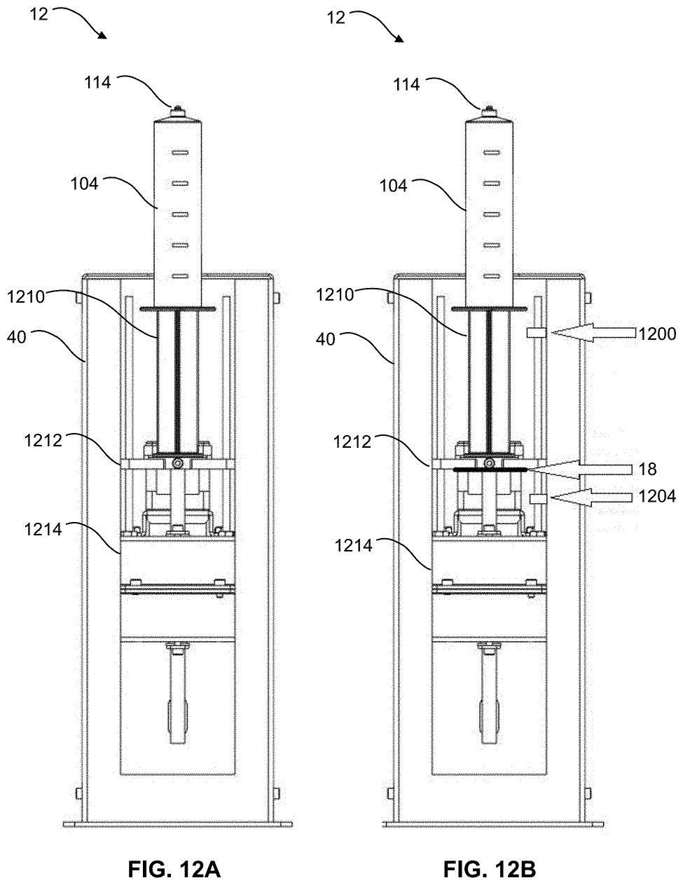

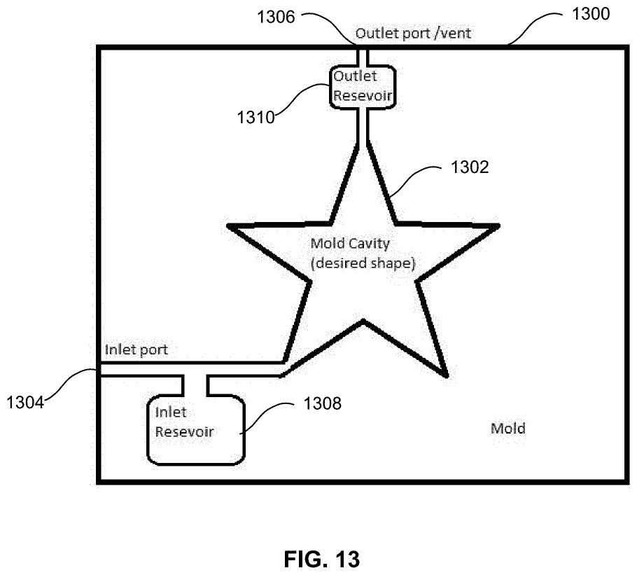

FIG. 3 illustrates another example implementation of the system 150. In this case, the mold 50 defines an interior cavity that, when injected with material, can produce an insole 52. FIG. 10 illustrates yet another example implementation of the system 150 for injection molding a mold 36.

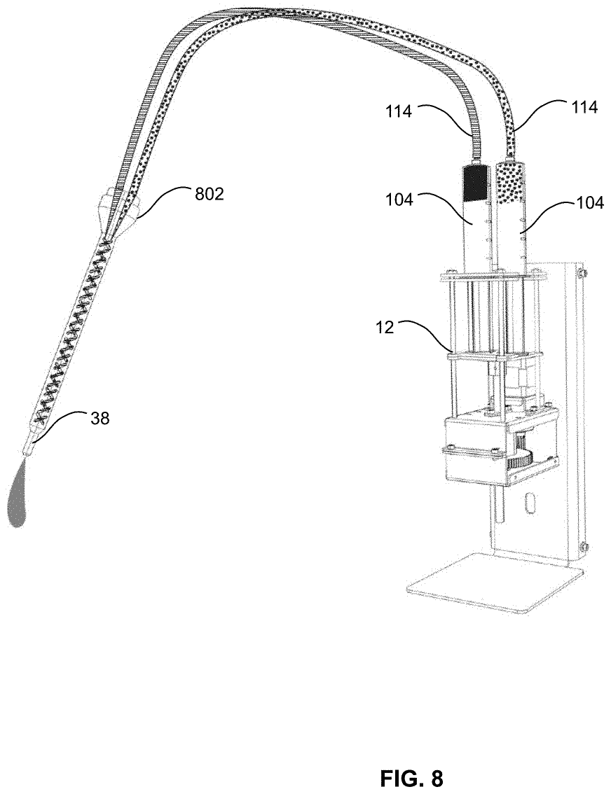

FIG. 8 illustrates another example implementation of the system 150, with the housing 40 removed for illustrative purposes. In this example, the system 150 includes two cartridges 104 on one extruder. The system 150 also includes a mixer element 802 (a static inline mixer in this embodiment) prior to, or as part of, the injection nozzle 38 that is inserted into the inlet 34. In this case, the static inline mixer 802 is a non-mechanical mixer; whereby the channels inside the mixer are designed to “fold” the two materials together from beginning to end. In further embodiments, the mixer could be an active mechanical mixer where the internal shaft of the mixer moves or rotates in order to mix the two (or more) materials.

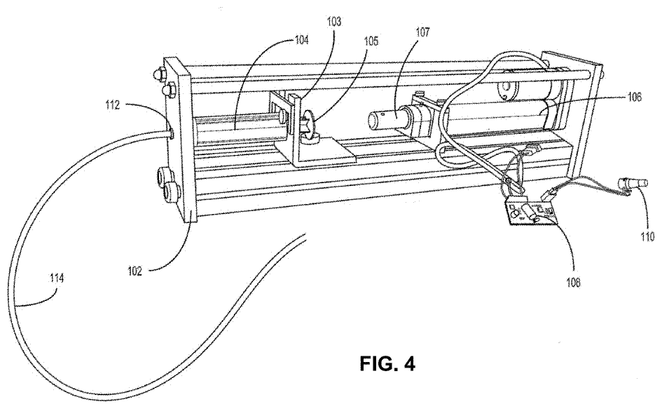

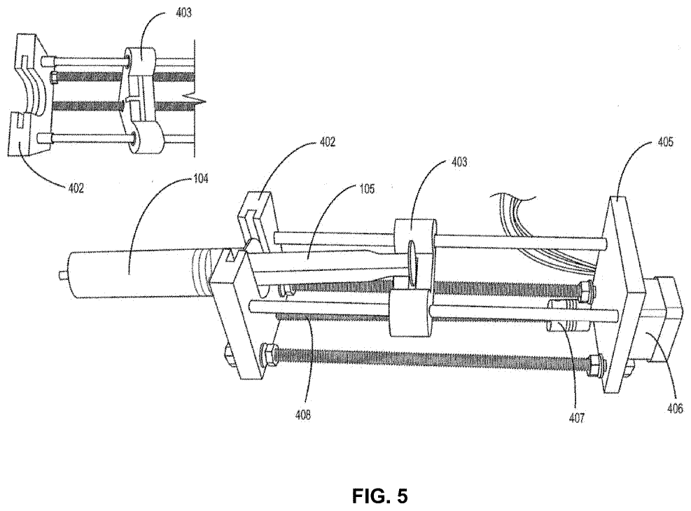

Referring to FIG. 4, shown is an illustrative example of an extruder 12 without the housing 40. As shown, in this example embodiment, the extruder 12 comprises a frame 102 adapted to receive a cartridge 104 with a depressible piston 105. The cartridge 104 can be, for example, a luer-lock syringe type, which can be securely mounted to the frame 102 by one or more brackets 103 mounted or mountable to the frame 102. At least one bracket 103 may be adjustably mounted to receive and secure the cartridge 104 of different lengths. Different sizes of brackets 103 may also be used to accommodate syringes or cartridges of different diameter or size, while still centering or properly positioning the cartridge 104 in the frame 102. The flexible length of tubing 114 is connected to the tip of the cartridge 104. The flexible length of tubing 114 may be connected, for example, by a luer-lock connector 112 to secure the tip of the cartridge 104 to the length of flexible tubing 114. However, it will be appreciated that any other suitable means to connect the flexible length of tubing 114 to the cartridge 104 is possible.

The opposite end of the flexible length of tubing 114 can be connected to the injection nozzle 38 to be injected. The flexible length of tubing 114 material may be chosen depending on the material to be extruded, and may be, for example, food grade plastic, or tubing coated with a non-stick material such as Teflon®. Although not essential, a transparent or translucent material for the flexible length of tubing 114 may be desirable such that extrusion of the material through the tubing can be visually confirmed.

Also included is a linear actuator motor 106 controlled by the controller 14 via a communication module 108. The linear actuator motor 106 is securely mounted to the frame 102 and substantially aligned with the piston 105 of the cartridge 104 to depress the piston 105. A potentiometer 110 can be used to control the amount of force to be applied by the linear actuator motor 106 depending on the type of material to be extruded. The communication module 108 may be mounted on the frame 102 or mounted remote from the frame 102.

In operation, the cartridge 104 is pre-filled with material to be extruded, with the depressible piston 105 in an extended position. The linear actuator motor 106 is then controlled by an extruder logic module comprising the motor control circuit 108 to depress the piston 105 of the cartridge 106 with an extendable shaft or rod 107 in order to achieve a desired rate of extrusion of the material. As will be explained in further detail below, the rate of extrusion may also be controlled by a feedback signal from one or more sensors adapted to sense the rate of extrusion of material.

Now referring to FIG. 5, shown is an illustrative example of an extruder 12 in accordance with another example embodiment. In this case, the barrel of the cartridge 104 is extending outside the frame and only its flange or end piece is received within a slot formed in an end piece 402 of the frame. The end piece 402 of the frame and the movable plunger gripper 403 may be made of metal, or alternatively a hard-plastic material to reduce weight and the build cost of the material.

In an embodiment, the end of an extending plunger 105 of the cartridge 104 is received within a movable plunger gripper 403. The movable plunger gripper 403 itself may include a slot to receive a flange provided on the end of the extending plunger 105. The movable plunger gripper 403 is slidably mounted to a plurality of metal rods positioned to provide structural support to the frame. For example, as shown in FIG. 5, four metal rods may be fastened to two end pieces of the frame, where the first end piece 402 receives the flange of the cartridge 104, and the second end piece 405 mounts an extrusion motor 406. The movable plunger gripper 403 may include linear bearings to guide the movable plunger gripper 403 more smoothly along the plurality of rods. In some cases, the movable plunger gripper 403 includes a threaded nut or Rampa™ insert 407 to engage and guide the movable plunger gripper 403 along the length of a threaded screw 408. The threaded screw 408 is coupled at one end to a shaft of extrusion motor 406. In an embodiment, the coupling may include a gearbox to generate sufficient torque using a smaller, less expensive motor than otherwise would be required for a direct drive extrusion motor. When the extrusion motor threaded screw 408 rotates in a first direction, the movable plunger gripper 403 moves towards the first end piece 402 of the frame, causing the plunger 105 to move into the barrel of the cartridge 104 and cause the material contained in the cartridge barrel 104 to be squeezed out. When the extrusion motor threaded screw 408 rotates in a second, opposite direction, the movable plunger gripper 403 moves away from the first end piece 402 of the frame, and positions the movable plunger gripper 403 to receive the next cartridge filled with material with an extended plunger

Still referring to FIG. 5, in some cases, the extruder 12 may further include a barcode or chip reader positioned near the cartridge 104 to read a label on the cartridge 104. The label may provide, for example, information regarding the properties of the materials contained in the cartridge 104. This information may be used to set a motor speed suitable for the material, for example. In another case, the information provided on the barcode label or chip provides instructions for preparing the materials prior to use. For example, the material may need to be pre-heated to a desired temperature prior to extrusion, and the information provided on the barcode label or chip may provide instructions for testing the temperature of the material prior to use, and heating the material with a heat source, if necessary, to a desired operating temperature. Thus, the information provided may also be used to operate one or more modules of the system.

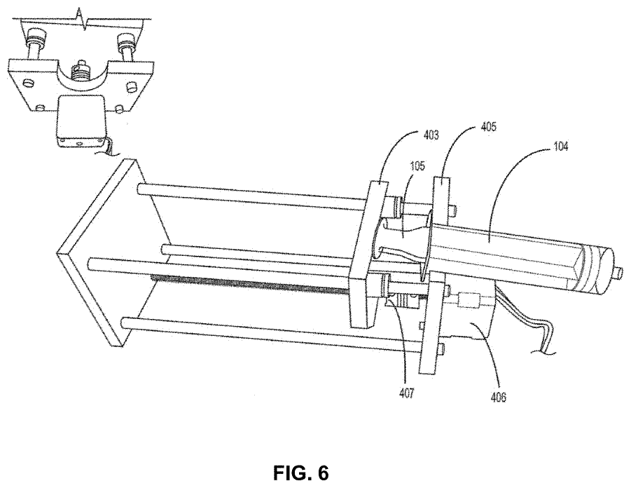

In some cases, the barrel of the cartridge 104 may receive a sensor 18 to detect the temperature of the material in the cartridge, which may determine how much pressure to apply to squeeze the material out. Now referring to FIG. 6, shown is another example of the extruder 12 in which the motor is mounted on the same end piece 405 of the frame that receives the flange of the cartridge barrel. In this case, the extrusion motor 406 is shown mounted below the cartridge barrel when it is received in the frame end piece. This alternative configuration leaves the other end piece free of any motor mounted on the outside of the frame, allowing the size of the frame to be potentially even further reduced.

In some cases, as the flow characteristics of different types of materials that can be injected may vary widely, it is desirable to provide feedback to the controller 14 to effectively control the speed and/or force of depression of the cartridge 104 such that the flow of extruded material is started, continues at a desired flow rate, or is stopped altogether. By way of example, a plurality of sensors 18 spaced apart along the flexible length of tubing 114. The sensors 18 may be spaced along a portion, or the entire flexible length of tubing 114 as may be required. In an embodiment, the sensors 18 may be optical sensor units incorporating a light source on one side of the tube and a light sensor on the opposite receiver side of the tube, whereby the sensor unit can sense when material has passed by. However, it will be appreciated that various other types of sensors 18 may also be used to determine when material has passed, or how quickly material is passing by. As material passes through the tubing, the plurality of sensors 18 determines the rate of extrusion of the material, and provides a feedback signal to the controller 14. The controller 14 can be configured to receive data from the sensors 18 and determine a viscosity estimate of paste material being extruded. The viscosity estimate can be determined in order to determine ideal extrusion parameters for driving the linear actuation motor 106 and its extendable rod 107.

In order to determine the viscosity estimate, the sensors 18 may detect the pressure and changes in the flow rate. In an embodiment, the linear actuator motor 106 can advance material at a defined pressure value, which can be verified via a recorded pressure value. By way of example, the material exits the cartridge 104 and enters the tubing 114, and the dimensions of the cartridge 104 and the smaller tubing 114 are known in advance. The time it takes for the material to travel through a defined length of tubing at a defined rate of pressure can then be used to estimate the viscosity of the material.

In addition, one or more force-type sensors 18 may be located at various pressure points on one or more of the frame 102, the cartridge 104, and the depressible piston 105, and the linear actuation motor 106 itself may also be used to determine the amount of force being applied to the cartridge 104, and to keep the linear actuation motor 106 within safe operating parameters.

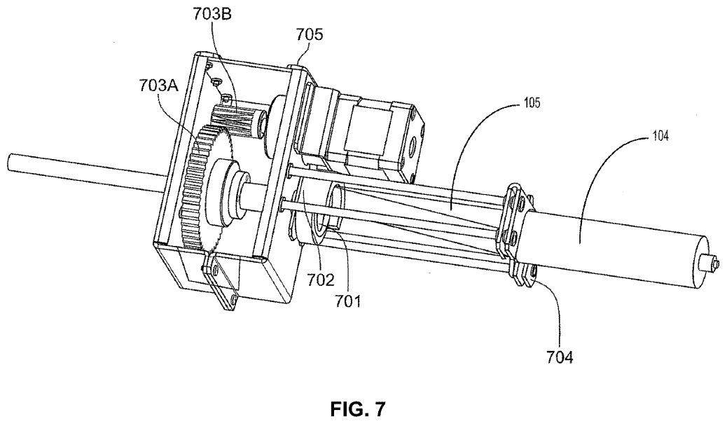

Now referring to FIG. 7, shown is another illustrative example of the extruder 12. In this example, the extruder now includes a minimal friction disk 701 positioned inside a cartridge cap at the end of the linear actuator in order to reduce possible rotational force against the cartridge plunger. A locking pin 702 may be used to connect the cartridge cap to the linear actuator. In this example, gearing 703A, 703B is also included to apply an appropriate linear force against the piston 105 of the cartridge 104. In this example, a custom cartridge cradle 704 can be provided, which is attached to support rods fixed at opposite ends to a frame 705. In order to provide sufficient strength, the gear and motor frame 705 is preferably made of a metal.

Now referring to FIGS. 12A and 12B, shown are further illustrative examples of the extruder 12. In this example, the cartridge 104 is extruded using an extrudable piston 1210 which is connected to the frame using a bracket 1212. An extendable shaft or rod 1214 depresses the piston 1210 in order to achieve a desired rate of extrusion of the material. In the example of 12B, there is also included an upper limit switch 1200 to provide a signal to the controller 14 that the material has been approximately completely extruded and a lower limit switch 1204 to provide a signal to the controller 14 that the cartridge is approximately completely full. Also included is a pressure sensor 18, as described herein.

FIG. 13 illustrates a front cut-away view of an example of a mold 1300, in accordance with embodiments described herein. In this example, an interior chamber 1302 is approximately shaped as a star. The mold 1300 defines an injection inlet port 1304 to receive material from the injection nozzle and an outlet port 1306 to allow for excess material to flow out of the mold 1300. The mold 1300 also includes an inlet reservoir 1308 and an outlet reservoir 1310 as an additional pocket to receive material in excess of what is required by the interior chamber 1302.

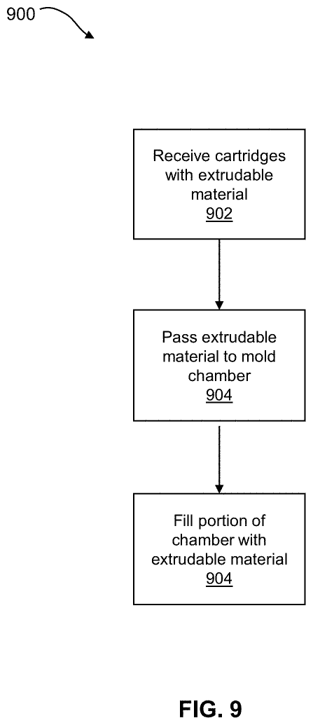

FIG. 9 is a flow chart showing a method for injection molding 900, according to an embodiment. The injection molding produces a three-dimensional object using a mold. A portion of the mold defining an interior chamber and defining an injection inlet from the interior chamber to the exterior of the mold. At block 902, one or more cartridges 104 are received by one or more extruders 12, with the one or more cartridges containing extrudable material. At block 904, The extrudable material from each of the one or more cartridges 104 is passed, via the tubing 114, to an injection nozzle 38 positioned into the injection inlet. At block 906, at least a portion of the interior chamber is filled with the extrudable material to produce the three-dimensional object.

While illustrative embodiments have been described above by way of example, it will be appreciated that various changes and modifications may be made without departing from the scope of the invention, which is defined by the following claims.

1. An injection mold system for producing a three-dimensional object using a mold, a portion of the mold defining an interior chamber and defining an injection inlet from the interior chamber to the exterior of the mold, the system comprising:
one or more extruders each adapted to receive one or more cartridges, the one or more cartridges containing extrudable material;
an injection nozzle dimensioned to be positioned into the injection inlet;
tubing each connecting one of the cartridges to the injection nozzle; and
one or more controllers configured to control flow of the extrudable material from the one or more extruders to the injection nozzle to pressure fill at least a portion of the interior chamber with the extrudable material to produce the three-dimensional object.

2. The injection mold system of claim 1, wherein the extrudable material comprises one of rubber, foam, and epoxy.

3. The injection mold system of claim 1, further comprising one or more pressure sensors positioned in association with the one or more cartridges to detect back pressure applied by the extrudable material against the one or more cartridges.

4. The injection mold system of claim 3, wherein the controller directs the one or more extruders to cease flow of the extrudable material when the sensed pressure is above a predetermined threshold.

5. The injection mold system of claim 3, wherein a previously molded object is located inside the interior chamber, and wherein flow of the extrudable material into the interior chamber produces the three-dimensional object as an overmolded object.

6. The injection mold system of claim 1, wherein the controller directs the one or more extruders to cease flow of the extrudable material when a predetermined volume of extrudable material has been injected into the interior chamber.

7. The injection mold system of claim 1, wherein one or more of the cartridges contains a gas that when directed into the interior chamber creates a void for blow molding.

8. The injection mold system of claim 1, wherein an insert is located inside the interior chamber, and wherein flow of the extrudable material into the interior chamber produces the three-dimensional object with the insert as part of the three-dimensional object.

9. The injection mold system of claim 8, wherein the insert is comprised of dissolvable material.

10. The injection mold system of claim 1, wherein the mold further comprises a pocket located between the interior chamber and the injection nozzle for receiving excess extrudable material.

11. The injection mold system of claim 1, wherein the controller controls extrusion speed at two or more of the extruders to inject extrudable material from each extruder at a predetermined mixing ratio.

12. The injection mold system of claim 1, wherein the mold comprises one or more vents between the interior chamber and the exterior of the mold to permit air to escape during flow of the extrudable material into the interior chamber.

13. A method for injection molding to produce a three-dimensional object using a mold, a portion of the mold defining an interior chamber and defining an injection inlet from the interior chamber to the exterior of the mold, the method comprising:
receiving one or more cartridges, the one or more cartridges containing extrudable material;
passing the extrudable material from each of the one or more cartridges to an injection nozzle positioned into the injection inlet; and
pressure filling at least a portion of the interior chamber with the extrudable material to produce the three-dimensional object.

14. The method of claim 13, wherein the extrudable material comprises one of rubber, foam, and epoxy.

15. The method of claim 13, further comprising detecting back pressure applied by the extrudable material against the one or more cartridges and ceasing flow of the extrudable material when the sensed pressure is above a predetermined threshold.

16. The method of claim 15, further comprising positioning a previously molded object inside the interior chamber, and wherein filling at least a portion of the interior chamber with the extrudable material produces the three-dimensional object as an overmolded object.

17. The method of claim 13, further comprising ceasing flow of the extrudable material when a predetermined volume of extrudable material has been injected into the interior chamber.

18. The method of claim 13, wherein one or more of the cartridges contains a gas, the method further comprising passing the gas into the interior chamber to create a void for blow molding.

19. The method of claim 13, further comprising positioning an insert inside the interior chamber, and wherein filling at least a portion of the interior chamber with the extrudable material produces the three-dimensional object with the insert as part of the three-dimensional object.

20. The method of claim 13, further comprising controlling extrusion of extrudable material from two or more cartridges at a predetermined mixing ratio.
